(19) United States
(12) Patent Application Publication
(10) Pub. No.: US 2018/0133918 A1
(43) Pub. Date: May 17, 2018

(54) DRILLING APPARATUS AND DRILLING METHOD

(71) Applicant: SHONAN GOSEI-JUSHI SEISAKUSHO K.K., Kanagawa (JP)

(72) Inventors: Takahiko ITOH, Kanagawa (JP); Takao KAMIYAMA, Kanagawa (JP); Akira KONNO, Saitama (JP)

(73) Assignee: Shonan Gosei-Jushi Seisakusho K.K., Kanagawa (JP)

(21) Appl. No.: 15/564,290

(22) PCT Filed: Mar. 7, 2016
(86) PCT No.: PCT/JP2016/057002

§ 371 Date: Oct. 4, 2017

(30) Foreign Application Priority Data
Apr. 7, 2015 (JP) 2015-078523

(51) Int. Cl. B26F 1/16; F16L 1/028; F16L 41/04

(52) U.S. Cl. CPC B26F 1/16; H04N 5/225; F16L 41/04; F16L 1/028

(57) ABSTRACT

Prior to lining a main pipe, a marker configured as a receiving coil 33 is disposed at the center 12b of a lateral pipe opening or at a position separated a predetermined distance S from the center thereof. An in-pipe robot 20 is loaded coaxially or separated by the predetermined distance with a rotatable drilling blade 31 for drilling a hole in a main pipe lining material 13 that blocks the lateral pipe opening and a transmitting coil 40 that detects a marker position. After lining the main pipe, the drilling blade and the transmitting coil are moved in conjunction in the main pipe longitudinal direction and in the main pipe circumferential direction to drill a hole in the main pipe lining material at a position where the electromagnetic coupling of both the coils becomes maximum. The center of rotation of the drilling blade coincides with the center of the lateral pipe opening at the position where the electromagnetic coupling of both the coils becomes maximum, so that a hole can be drilled precisely in the main pipe lining material in alignment with the lateral pipe opening.

### TECHNICAL FIELD

The present invention relates to a drilling apparatus and drilling method for drilling a hole in a main pipe lining material that blocks a lateral pipe opening.

When an existing pipe such as a sewer pipe buried underground has deteriorated, a pipe lining method for lining the existing pipe using a pipe lining material has been used to rehabilitate the existing pipe without digging up the pipe. The pipe lining material includes a resin absorbing material made of a flexible tubular non-woven fabric having a shape corresponding to that of the existing pipe. The resin absorbing material is impregnated with an uncured liquid setting resin and is coated at its external peripheral surface with a highly airtight plastic film. In the lining work, the lining material is everted and inserted into the existing pipe by means of fluid pressure, or pulled into the existing pipe without everting. The lining material is then pressed against the internal circumferential surface of the existing pipe, and the liquid setting resin impregnated in the pipe lining material is heated and cured to line the pipe.

Commonly, a lateral pipe communicates with a main pipe such as a sewer pipe. When the main pipe is lined with the pipe lining material, the pipe lining material blocks the opening at the end of the juncture of the lateral pipe. Therefore, an in-pipe work robot provided with a drill and a TV camera is transported into the main pipe and operated remotely from aboveground. The cutter (rotary blade) of the drill is driven and rotated to drill through from the main pipe and remove the portion of the pipe lining material that blocks the end of the lateral pipe.

However, in this work, the cutter of the drill must be positioned in the longitudinal direction, in the circumferential direction and in the vertical direction of the main pipe prior to drilling. This is accomplished while monitoring the main pipe interior with a TV camera. However, since there is no marker in the main pipe interior, there are cases in which mistakes are made in positioning; i.e., mistakes are made in the drilling positions.

As a countermeasure, the following Patent Document 1 discloses a method in which a cap member made of conductive or magnetic material is fitted into a branch opening of the lateral and main pipes, and, after lining the main pip, a lining portion at which the transition of permittivity or permeability of the cap member becomes maximum is detected as a branch opening of the lateral pipe using a detector on the in-pipe work robot to drill a hole in the main pipe lining material that blocks the branch opening.

Patent Document 2 disclose an arrangement in which a magnetism generator is disposed on the lateral pipe side; a magnetic detector is moved along the lined main pipe to detect magnetism from the magnetism generator; and a branch opening of the lateral and main pipes is detected to cut the lining material that blocks the branch opening.

Patent Document 3 discloses an arrangement in which a marker comprised of a coil and a resonator is embedded coaxially with the pipe axis of the lateral pipe, and, after lining the main-pipe, the marker is magnetically excited by a loop antenna that is provided on a drilling robot. In this arrangement, the marker resonates at a resonance frequency when the loop antenna approaches the branch opening, and a position at which the receiving signal from the resonance signal becomes minimum in level is detected as a center position of the branch opening to perform the drilling work.

### PRIOR ART DOCUMENTS

### Patent Documents

Patent Document 1: JP 2002-22062 A

Patent Document 2: JP 2008-142827 A

Patent Document 3: JP H7-88915 A1

### SUMMARY OF INVENTION

### Problems to be Solved

However, the arrangement in Patent Document 1 needs to prepare the cap member made of conductive or magnetic material, having the disadvantage that the cap member is expensive to manufacture and the detector cannot precisely detect a position where the transition of permittivity or permeability of the cap member becomes maximum.

The arrangement in Patent Document 2 also has the disadvantage that the magnetism generator must be mounted so as to coincide with the axis of the lateral pipe, and, due to its incomplete positioning, it is difficult to precisely detect the center of the branch opening of the lateral and main pipes.

The arrangement in Patent Document 3 also has the disadvantage that a piezoelectric oscillator such as a quartz oscillator is needed to manufacture the marker, and the excitation signal from the marker is not sharp. This makes it difficult to detect the center position of the branch opening.

In any Patent Document, the sensor is moved in the main pipe longitudinal direction to detect the drilling marker, so that, when the marker is mounted offset in the main pipe circumferential direction, the marker cannot be detected. This makes it necessary to move the sensor in the circumferential direction and redo the detection, causing the drilling efficiency to be reduced.

It is therefore an object of the present invention to solve the problems and provide a drilling apparatus and a drilling method being capable of precisely positioning the rotation axis of the drilling blade to the center of the lateral pipe opening to drill a hole in the main pipe lining material that blocks the lateral pipe opening.

### Means for Solving the Problems

The present invention relates to a drilling apparatus for drilling a hole from a main pipe side in a main pipe lining material that blocks a lateral pipe opening, comprising:

an in-pipe robot that moves inside the main pipe;

a rotatable drilling blade mounted on the in-pipe robot to drill a hole in the main pipe lining materials;

a sensor mounted on the in-pipe robot to detect the position of a marker that is disposed at the center of the lateral pipe opening or at a position separated a predetermined distance from the center thereof; and

moving means for moving the drilling blade and the sensor in conjunction in the main pipe longitudinal direction and in the main pipe circumferential direction,

wherein the sensor is mounted at the center of rotation of the drilling blade or at a position separated the predetermined distance from the center of rotation thereof, and the drilling blade and the sensor are moved in conjunction in the main pipe longitudinal direction and in the main pipe circumferential direction until the marker is detected, a hole being drilled in the main pipe lining material at the position at which the marker is detected.

In the present invention, the marker is a coil, and the sensor is a coil that generates a fluctuating magnetic flux. The center of the sensor coil at which the electromagnetic coupling of the marker coil and the sensor coil becomes maximum is detected as a marker position. Alternatively, the marker is a magnet, and the sensor is a magnetic sensor. A position where a magnetic sensor signal becomes maximum is detected as a marker position.

The present invention also relates to a drilling method for drilling a hole from a main pipe side in a main pipe lining material that blocks a lateral pipe opening, comprising;

disposing, prior to lining a main pipe, a marker at the center of the lateral pipe opening or at a position separated a predetermined distance from the center thereof; and,

moving, after lining the main pipe, in conjunction inside the main pipe a sensor that detects a marker position and a rotatable drilling blade that drills a hole in the main pipe lining material,

wherein the sensor is mounted at the center of rotation of the drilling blade or at a position separated the predetermined distance from the center of rotation thereof, and the sensor and the drilling blade are moved in the main pipe longitudinal direction and in the main pipe circumferential direction until the sensor detects the marker position, a hole being drilled in the main pipe lining material at the position at which the marker is detected.

### Effect of the Invention

In the present invention, the marker is disposed at the center of the lateral pipe opening or at a position separated a predetermined distance from the center thereof, and a sensor that detects the marker position is mounted at the center of rotation of the drilling blade or at a position separated the predetermined distance from the center of rotation thereof. The drilling blade and the sensor are moved in conjunction in the main pipe longitudinal direction and in the main pipe circumferential direction until the marker is detected, and a hole is drilled in the main pipe lining material at the position at which the marker is detected. This makes it possible to precisely align the center of rotation of the drilling blade with the center of the lateral pipe opening and precisely cut the main pipe lining material that blocks the lateral pipe opening in alignment therewith.

### BRIEF DESCRIPTION OF DRAWINGS

FIG. 1 is an illustrative view showing a state in which a drilling apparatus is moved inside a main pipe;

FIG. 2a is a perspective view showing a receiving coil mounted on the inner circumferential surface of the main pipe;

FIG. 2b is a vertical cross-sectional view of the receiving coil;

FIG. 3a is an illustrative view showing a step for mounting the receiving coil on the inner circumferential surface of the main pipe;

FIG. 3b is an illustrative view showing a step following the step in FIG. 3a;

FIG. 4a is an illustrative view showing a state in which the receiving coil has been mounted on the inner circumferential surface of the main pipe;

FIG. 4b is an illustrative view showing a state in which the main pipe has been lined;

FIG. 5a is an illustrative view showing a state in which an in-pipe robot equipped with a drilling blade and a transmitting coil is moved inside the pipe;

FIG. 5b is an illustrative view showing a state in which the receiving coil and the transmitting coil are coupled electromagnetically;

FIG. 6a an illustrative view showing a state in which the drilling blade is lifted and rotated to drill a hole in the main pipe lining material at the position at which the electromagnetic coupling of the receiving coil and the transmitting coil becomes maximum;

FIG. 6b is an illustrative view showing a state in which a hole is drilled in a lateral pipe opening and it is made open;

FIG. 7a is a top view of the transmitting coil;

FIG. 7b is a cross-sectional view along the line A-A in FIG. 7a;

FIG. 8 is a circuit diagram showing a configuration for controlling the drilling apparatus;

FIG. 9a is an illustrative view showing a state in which the electromagnetic coupling varies when the transmitting coil is moved in the main pipe longitudinal direction;

FIG. 9b is an illustrative view showing a state in which the electromagnetic coupling varies when the transmitting coil is swung around the axis of the main pipe in the circumferential direction thereof;

FIG. 10a is a perspective view showing partially in cross section a cap for mounting the receiving coil at the lateral pipe opening;

FIG. 10b is a vertical cross-sectional view of the cap as viewed in the main pipe longitudinal direction;

FIG. 11a is an illustrative view showing a state in which the in-pipe robot is moved to the mount position of the receiving coil;

FIG. 11b is an illustrative view showing a state in which the receiving coil is mounted to the lateral pipe opening;

FIG. 12a is an illustrative view showing a state in which the in-pipe robot is moved to the position at which the electromagnetic coupling of the receiving coil and the transmitting coil becomes maximum;

FIG. 12b is an illustrative view showing a state in which a hole is drilled in the main pipe lining material at the position at which the electromagnetic coupling becomes maximum;

FIG. 13a is an illustrative view showing a state in which a hole is drilled in the main pipe lining material;

FIG. 13b is an illustrative view showing a state in which a hole has been drilled in the main pipe lining material;

FIG. 14a is a top view of a transmitting coil;

FIG. 14b is a cross-sectional view along the line A-A in FIG. 14a;

FIG. 15 is a cross-sectional view of a lateral pipe lining material to which the receiving coil is mounted;

FIG. 16a is an illustrative view showing a state in which the in-pipe robot is moved to the position of a lateral pipe that is lined with a lateral pipe lining material;

FIG. 16b is an illustrative view showing a state in which a hole is drilled in the main pipe lining material at the lateral pipe position;

FIG. 17a is an illustrative view showing a state in which the drilling is performed using an embodiment that modifies the drilling apparatus in Embodiment 1;

FIG. 17b is an illustrative view showing a state in which the drilling is performed using an embodiment that modifies the drilling apparatus in Embodiment 2;

FIG. 18a is a front view of a magnet that is mounted as a marker on the inner circumferential surface of the main pipe;

FIG. 18b is a cross-sectional view showing a state in which the magnet as a marker is mounted on a cap that is fitted to the lateral pipe opening;

FIG. 19a is an illustrative view showing a state in which the drilling is performed using a magnetic sensor that detects the magnet mounted on the inner circumferential surface of the main pipe; and

FIG. 19b is an illustrative view showing a state in which the drilling is performed using a magnetic sensor that detects the magnet mounted on the cap inserted into the lateral pipe opening.

### MODE OF CARRYING OUT THE INVENTION

### Embodiments

The present embodiments according to the present invention will now be described with reference to the attached drawings. The embodiments are described for a case in which a main pipe of a sewer pipe is exemplified as an existing pipe, and, after lining the sewer pipe with a main pipe lining material, a lateral pipe opening blocked by the main pipe lining material is made through. However, the present embodiments can be applied not only for the sewer pipe, but also for a case in which a main pipe such as a water pipe or a gas pipe is lined, and the lateral pipe opening blocked by the main pipe lining material is then made through.

### Embodiment 1

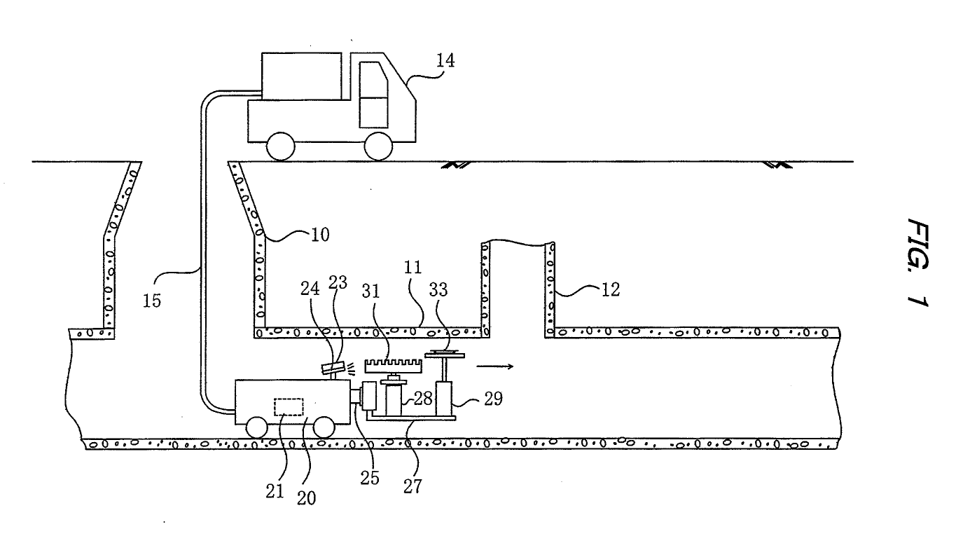

FIG. 1 shows a state in which a main pipe 11 of the sewer pipe is embedded underground. The main pipe 11 is opened to the ground through a manhole 10 that is arranged at predetermined distances. A plurality of lateral pipes (also called branch pipes or mount pipes) branch off in the main pipe between the two manholes, and sewage from homes or buildings is discharged through the lateral pipe to the main pipe. FIG. 1 shows one of the lateral pipes 12. The lateral pipe 12 extends in the direction orthogonal to the main pipe 11, but may be oblique thereto at an angle of, for example, 60 degrees. The present invention can also be applied to drilling a hole in a main pipe lining material that blocks an opening of such an oblique lateral pipe.

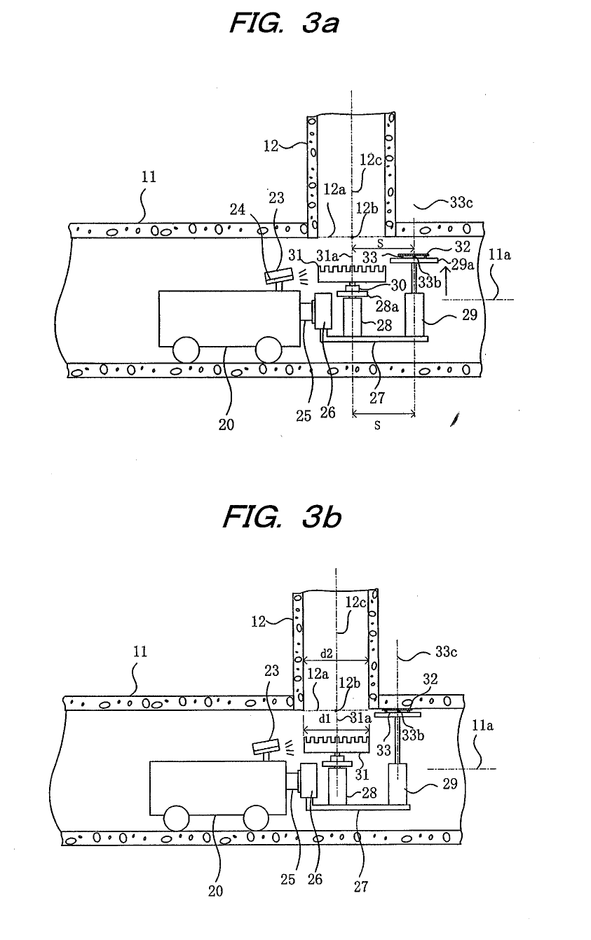

As shown in FIGS. 1 and 3a, a drilling apparatus includes an in-pipe robot 20 that is equipped with a drilling blade 31 and moves inside the main pipe 11 in the longitudinal direction thereof (in the horizontal direction). The in-pipe robot 20 is provided with four wheels (only two wheels visible in the drawings), and can be moved forward and backward in the main pipe longitudinal direction by driving a motor 21 in the in-pipe robot 20 or by winching on the ground a wire (not shown) that is connected to the in-pipe robot 20 at the front and rear thereof. A television camera 23 is mounted on the top of the in-pipe robot 20, and is provided at one side or both sides with a lighting device 24. The television camera 23 and the lighting device 24 face diagonally upwards, and the main pipe interior illuminated by the lighting device 24 is photographed by the television camera 23 and displayed on a monitor (not shown) inside a work truck 14 installed on the ground so that an operator can monitor the main pipe interior.

Although not shown, a truck loaded with accessories may be linked to the in-pipe robot 20. In the present invention, the in-pipe robot 20 may include such a truck that is linked to the in-pipe robot 20 for movement.

A motor 25 is mounted in front of the in-pipe robot 20 to swing a mount 26 and a support plate 26 fixed thereto over a range of a predetermined angle about an axis that is parallel to the axis 11a of the main pipe 11. Cylinders 28, 29 with disc-shaped heads 28a, 29a at the top are spaced apart a predetermined distance and fixed on the support plate 27.

The drilling blade 31 that is configured as a hole saw with bits at the top is mounted to a head 28a of the cylinder 28 such that the rotation axis 31a thereof is coaxial with the center axis (piston axis) of the cylinder 28. As shown in FIG. 3b, the drilling blade 31 has an outer bit-diameter d1 substantially the same as or slightly smaller than the inside diameter d2 of the lateral pipe. The drilling blade 31 is lifted or lowered in the vertical direction by hydraulic pressure using the cylinder 28 and is rotated by a motor 30.

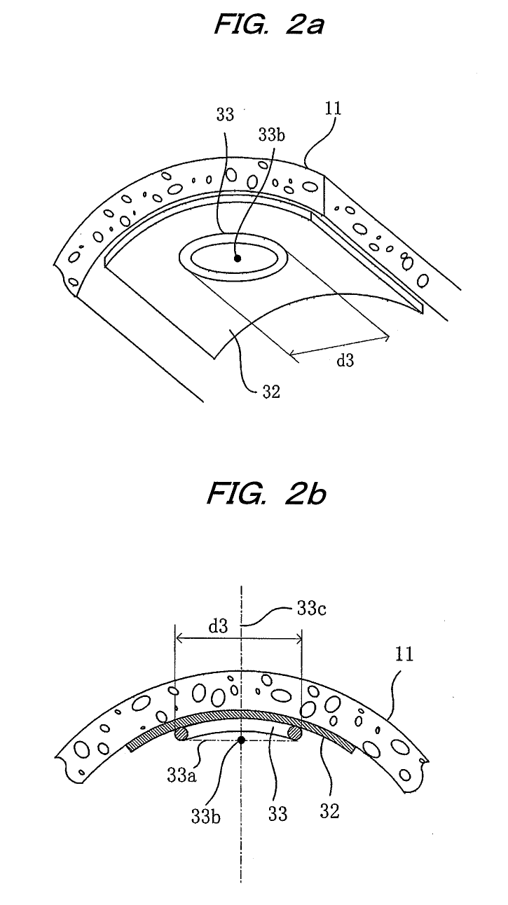

The cylinder 29 has its head 29a bent according to the curvature of the inner circumferential surface of the main pipe. Disposed on the head 29a is, as shown in FIG. 2, a flexible board 32 provided with a receiving coil 33 (second coil) that serves as a marker indicating a position of drilling center. The receiving coil 33 is a conductor through which an induced current flows due to fluctuating magnetic flux. In the present embodiment, the receiving coil 33 is shown as a one-turn of circular coil made of closed copper wire, but it may be a multi-turn coil, or a hollow cylindrical member or a disc through which an induced current flows due to fluctuating magnetic flux.

The receiving coil 33 is fixed to the board 32 with an adhesive or an adhesive tape. As shown in FIG. 3b, the head 29a of the cylinder 29 is lifted to press the board 32 against the inner circumferential surface of the main pipe 11. As shown in FIGS. 2a and 3b, the board 32 and the receiving coil 33 are bent according to the curvature of the main pipe and are fixed to the board 32 with an adhesive applied to the back side thereof in a state in which they are bent according to the curvature of the main pipe. As shown in FIG. 2b, the bent receiving coil 33 has a contour that draws a dash-dotted coil plane 33a with a diameter d3, which is parallel to the generatrix of the main pipe 11. Symbol 33c shows a center 33b of the coil plane 33a, or a center axis that passes through the center of the receiving coil 33 before being bent (center axis of the second coil).

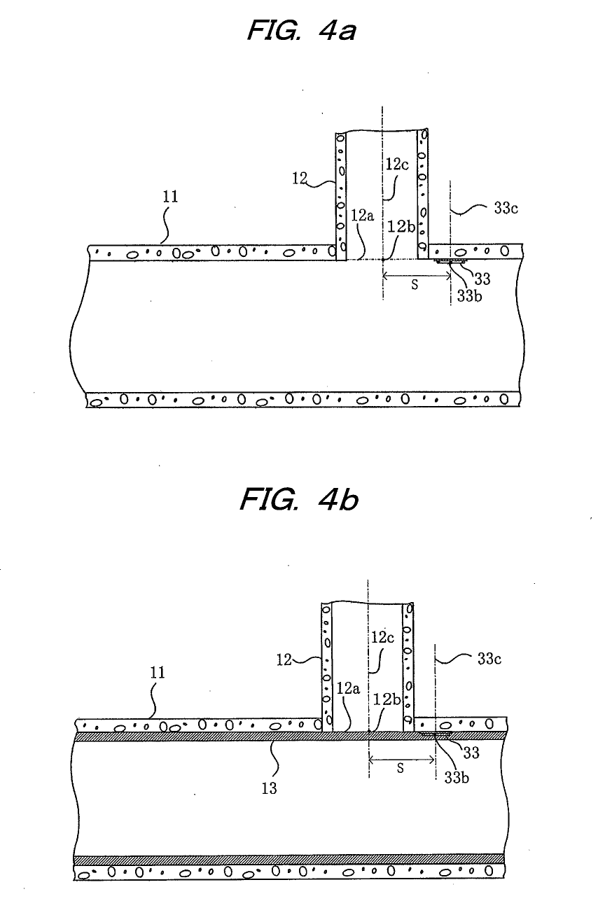

The receiving coil 33 is, as shown in FIGS. 4a and 4b, disposed at the position at which the distance S between the center 33b thereof and the center 12b of the lateral pipe opening 12a is equal to the longitudinal distance along the pipe between the center axes of the cylinders 28, 29 (piston axes), for example.

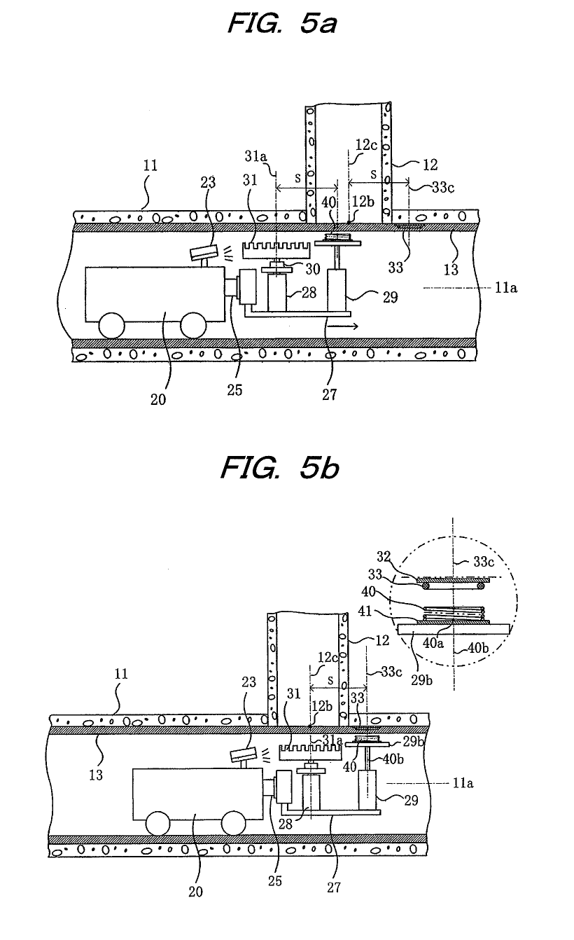

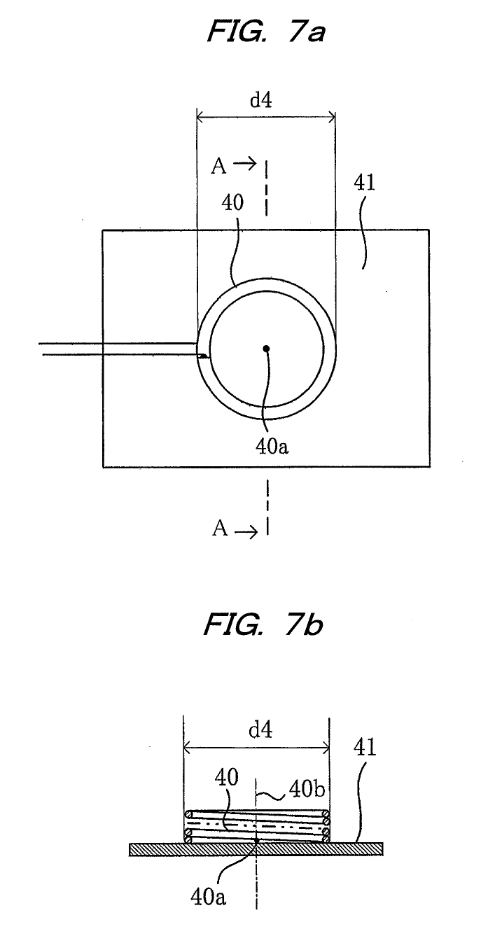

The cylinder 29 is provided at the head 29 with a board 41 to which a transmitting coil (first coil) 40 as shown in FIGS. 5a, 5b and 7 is mounted to detect the marker position. In order to increase the excitation force, the transmitting coil 40 is configured as a circular multi-turn coil with lead wires connected to one and the other ends thereof. The diameter d4 of the transmitting coil 40 is substantially the same as the diameter d3 of the receiving coil 33, and its coil center is shown by symbol 40a. Symbol 40b shows the center axis (center axis of the first coil) that passes through the coil center 40a and extends vertically relative to its coil plane.

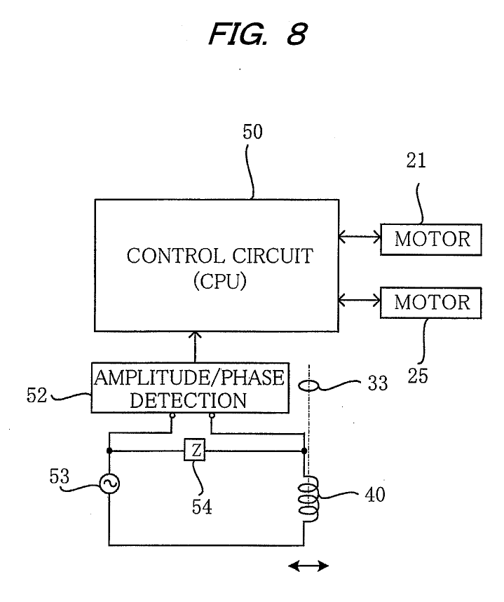

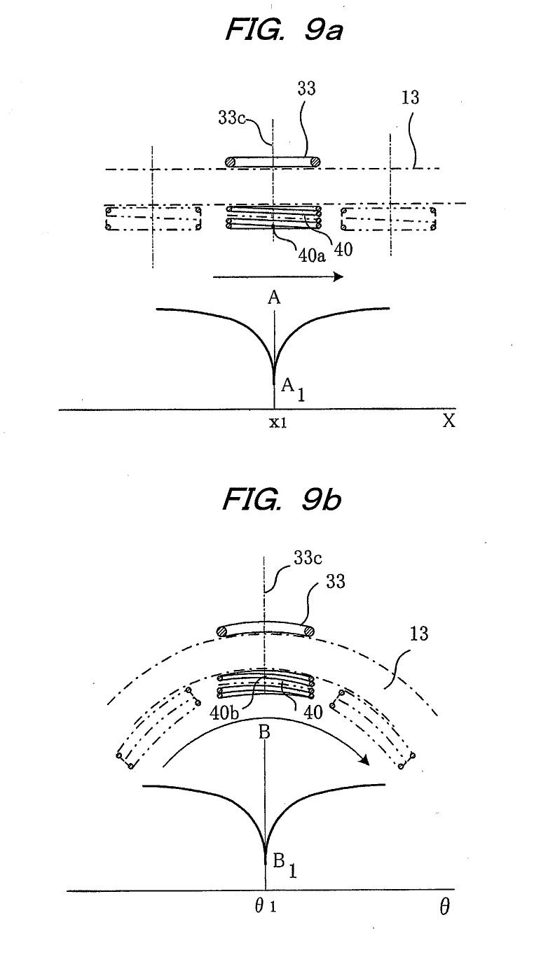

As schematically shown in FIG. 8, the transmitting coil 40 has its one end connected to an AC power supply 53 and the other end to an impedance circuit 54. An alternating current flows through the transmitting coil 40 and a fluctuating magnetic flux is generated in the coil loop thereof with its direction changing according to the alternating current. The fluctuating magnetic flux acts on the receiving coil 33 to cause an induced current to flow through the receiving coil 33 due to electromagnetic induction. The larger the electromagnetic coupling between the transmitting coil 40 and the receiving coil 33, i.e., the larger the density of fluctuating magnetic flux due to the transmitting coil 40 through the coil loop thereof, the larger the induced current flowing through the receiving coil 33 and the smaller the inductance of the transmitting coil 40. An amplitude/phase detection circuit 52 determines the difference between the voltage of the AC power supply and the voltage across the impedance circuit 54 as a voltage across both the terminals of the transmitting coil 40 to detect the amplitude/phase thereof. For the great electromagnetic coupling and the reduced inductance of the transmitting coil 40, the output value from the amplitude/phase detection circuit 52, i.e., the amplitude of the voltage across both the terminals of the transmitting coil 40 decreases, as shown in FIGS. 9a and 9b, and the phase angle thereof advances.

The power supply connected to the transmitting coil 40 may be not only an AC power supply but also a power supply that generates a pulsating current or continuous pluses as long as it is a power supply that generates a fluctuating magnetic flux in the transmitting coil.

The motors 21, 25 are respectively configured as a servomotor. A control circuit 50 that is realized by CPU detects a peak value (minimum) of amplitude and/or phase of the voltage detected by the amplitude/phase detection circuit 52 and drives the motor 21, 25 to move the transmitting coil 40 and the drilling blade 31 to a position at which the voltage amplitude and/or voltage phase is at the peak value, i.e., to a position where the electromagnetic coupling of the receiving coil 33 and the transmitting coil 40 becomes maximum and the center axes of both the coils coincide with each other. The control circuit 50, the amplitude/phase detection circuit 52, the AC power supply 53 and the like are mounted inside the in-pipe robot 20.

The driving means such as the motors 21, 25, 30, the cylinders 28, 29 and the like have power supply lines connected through a cable pipe 15 to a power supply loaded on the work truck 14, and are independently driven or controlled by switches, joysticks and the like arranged on a console mounted on the work truck.

In drilling, the drilling blade 31 and the transmitting coil 40 are swung in the main pipe circumferential direction around the pipe axis thereof. For this reason, the motor 25 is configured so as to be movable vertically by manual or a cylinder (not shown) inside the in-pipe robot 20.

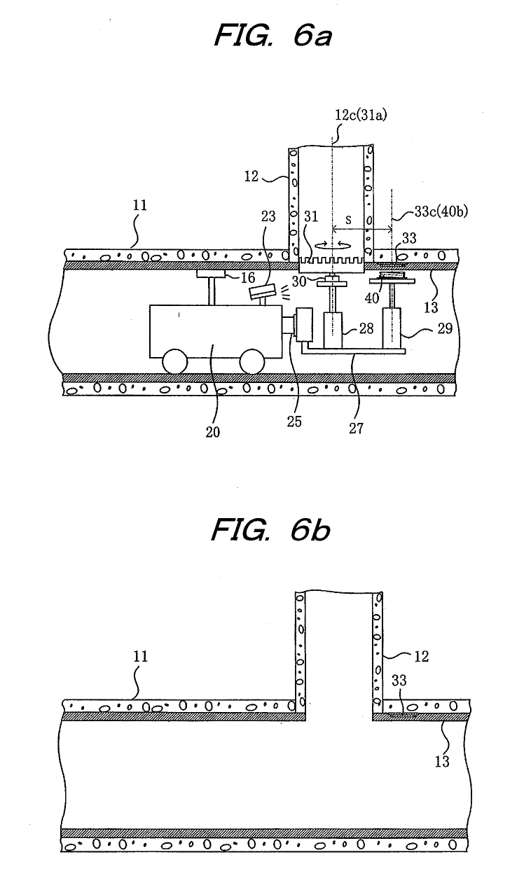

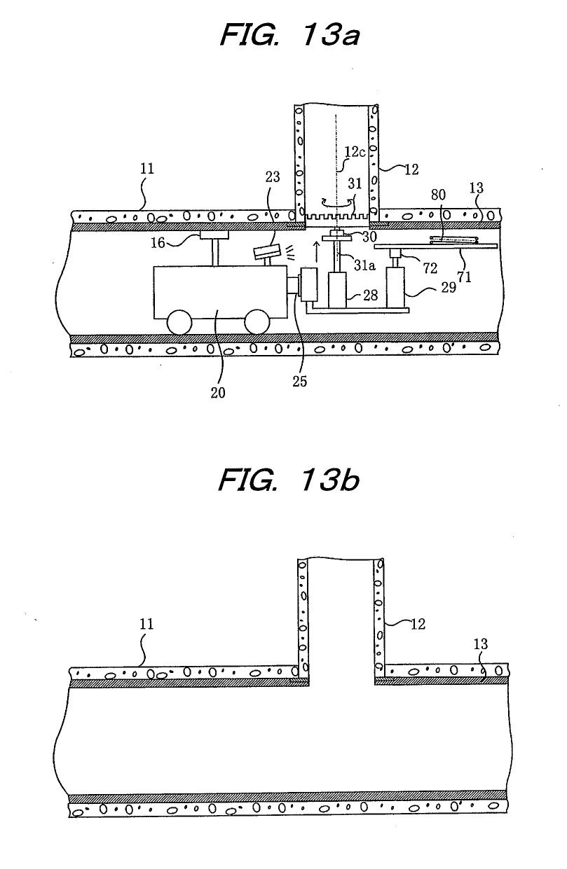

The in-pipe robot 20 is also equipped with a bracing member 16 (FIGS. 6a and 13a) as described later in order to stabilize the position thereof during drilling.

The operation of the drilling apparatus thus configured will be described.

In the present embodiment, prior to lining the main pipe 11 with the main pipe lining material, the receiving coil 33 is mounted on the inner circumferential surface of the main pipe in order to center the drilling blade 31 to the lateral pipe opening 12a. For this end, the receiving coil 33 is mounted on the head 29s of the cylinder 29 such that its center axis 33c coincides with the center axis of the cylinder 29, as shown in FIGS. 1, 3a and 3b.

As shown in FIG. 3a, the in-pipe robot 20 is then moved to a position at which the rotation axis 31a of the drilling blade 31 coincides with the center axis 12c that extends vertically through the center 12b of the lateral pipe opening 12a. In order to make sure that the in-pipe robot is moved to that position, the cylinder 28 is operated to lift the drilling blade 31 and it is observed through the image obtained by the television camera 23 whether or not the drilling blade 31 can be inserted into the lateral pipe opening 12a.

When the in-pipe robot 20 is moved as described above and the rotation axis 31a of the drilling blade 31 becomes coaxial with the center axis 12c of the lateral pipe opening 12a, the cylinder 29 is driven to lift its head 29a and press the board 32 against the inner circumferential surface of the main pipe 11. This allows the board 32 and the receiving coil 33 to be bent according to the curvature of the main pipe 11 as shown in FIGS. 2a and 2b for fixation to the inner circumferential surface of the main pipe 11 via an adhesive applied to the rear surface of the board 32.

The drilling blade 31 is mounted such that its rotation axis 31a is coaxial with the center axis of the cylinder 28, and the receiving coil 33 is mounted such that its center axis 33c coincides with the center axis of the cylinder 29. Therefore, when the receiving coil 33 is mounted on the inner circumferential surface of the main pipe by the in-pipe robot 20, the distance S (FIG. 4) between the center 33b of the receiving coil 33 and the center 12b of the lateral pipe opening is equal to the distance between the center axes of the cylinders 28, 29 along the main pipe longitudinal direction.

Next, the in-pipe robot 20 is removed from the main pipe 11 to the outside thereof, as shown in FIG. 4a, and the inner circumferential surface of the main pipe 11 is lined with the main pipe lining material 13, as shown in FIG. 4b. As is well known, the lining is performed by introducing the main pipe lining material 13 into the main pipe using an eversion method or a pulling method and curing the liquid setting resign impregnated in the main pipe lining material 13. The lining allows the receiving coil 33 is embedded in the main pipe lining material 13 and fixed to the main pipe.

The transmitting coil 40 disposed on the board 41 is then mounted on the head 29a of the cylinder 29 in the in-pipe robot 20 such that the center axis 40b thereof coincides with the center axis of the cylinder 29. As shown in FIG. 5a, in-pipe robot 20 is moved toward the receiving coil 33 with the coil surface of the transmitting coil 40 made close to the inner circumferential surface of the main pipe.

When the transmitting coil 40 approaches the receiving coil 33 and the electromagnetic coupling of both the coils becomes strong, the amplitude value A of voltage of the amplitude/phase detection circuit 52 becomes small, as shown in FIG. 9a. As soon as the center axis 40b of the transmitting coil 40 coincides with the center axis 33c of the receiving coil 33, the electromagnetic coupling of both the coils becomes maximum and the amplitude value A of voltage of the amplitude/phase detection circuit 52 is the minimum value A. The control circuit 50 servo-controls the motor 21 to a position where the amplitude value A of voltage of the amplitude/phase detection circuit 52 is at the minimum value A (a position where the electromagnetic coupling of the receiving coil 33 and the transmitting coil 40 becomes maximum), i.e., at a position x1 at which the center axes 40b, 33c of the transmitting coil 40 and the receiving coil 33 coincide. The in-pipe robot 20 thus stops at the position x1.

FIG. 5b shows a state in which the in-pipe robot 20 stops with the coil portions being shown enlarged. The distance along the pipe-length direction between the center axis of the transmitting coil 40 and the rotation axis 31a of the drilling blade 31 is equal to the distance between the center axes of the cylinders 28, 29, i.e., the distance S between the center 33b of the receiving coil 33 and the center 12b of the lateral pipe opening. Accordingly, when the receiving coil 33 and the transmitting coil 40 become coaxial, the rotation axis 31a of the drilling blade 31 becomes coaxial with the center 12b of the lateral pipe opening as well as the center axis 12c of the lateral pipe opening passing therethrough.

As soon as the receiving coil 33 and the transmitting coil 40 are coaxial and the electromagnetic coupling of both the coils is maximum, the in-pipe robot 20 stops and, at this stop position, the rotation axis 31a of the drilling blade 31 passes through the center 12b of the lateral pipe opening and is coaxial with the center axis 12c of the lateral pipe opening. The cylinder 28 is then raised, as shown in FIG. 6a, and the motor 30 is driven to rotate the drilling blade 31 and drill a hole in the main pipe lining material 13. When drilling, the bracing member 16 housed in the in-pipe robot is lifted against the upper surface of the main pipe to stabilize the in-pipe robot 20. The drilling blade 31 has a diameter the same as or slightly smaller than the inside diameter of the lateral pipe 12, so that a circular hole corresponding to the circle of the inner diameter of the lateral pipe is, as shown in FIG. 6b, drilled in the main pipe lining material 13 that blocks the lateral pipe opening, thus communicating the lateral pipe 12 with the main pipe 11.

In the above described embodiment, it is assumed that the rotation axis 31a of the drilling blade 31 is oriented vertically as viewed in the main pipe circumferential direction, but may be inclined in the main pipe circumferential direction. Accordingly, the motor 25 is driven at the stop position of the in-pipe robot to swing the transmitting coil 40 and the drilling blade 31 about the center axis of the main pipe, i.e., the main pipe axis 11a extending horizontally in the pipe-length direction for movement into a position where the electromagnetic coupling of the transmitting coil 40 and the receiving coil 33 becomes maximum, i.e., into a position θ1 where the amplitude value B of the amplitude/phase detection circuit 52 is the minimum value B1 and the transmitting coil 40 and the receiving coil 33 are coaxial, as shown in FIG. 9b.

The transmitting coil 40 and the drilling blade 31 is thus moved in the main pipe longitudinal direction as well as in the main pipe circumferential direction to the position where the electromagnetic coupling of the transmitting coil 40 and the receiving coil 33 becomes maximum and the center axes of both the coils coincide, so that the axis 31a of the drilling blade 31 can be positioned to the center 12b of the lateral pipe opening or the center axis 12c thereof, allowing a hole to be drilled precisely in the main pipe lining material.

In the above-mentioned embodiment, the in-pipe robot 22 is used to mount the receiving coil. In a case in which another robot is used for mount, the distance between the center 33b of the receiving coil 33 and the center 12b of the lateral pipe opening may be different from the distance along the pipe-length direction between the center axes of the cylinders 28, 29. In such a case, the robot may be equipped with a mechanism for moving the cylinder 28 and/or the cylinder 29 of the in-pipe robot 20 in the pipe-length direction, and the cylinder 28 and/or the cylinder 29 are adjusted so that the distance along the pipe-length direction between the center axis of the transmitting coil 40 and the axis of rotation of the drilling blade is equal to the distance S between the center of the receiving coil 33 and the center of the lateral pipe opening.

In a case in which the distance between the center 33b of the receiving coil 33 and the center 12b of the lateral pipe opening is different from a distance along the pipe-length direction between the center axes of the cylinders 28, 29, a difference therebetween may be determined for drilling in order to move the in-pipe robot 20 by the difference from the position where the electromagnetic coupling of the transmitting coil 40 and the receiving coil 33 becomes maximum, thereby positioning the rotation axis 31a of the drilling blade 31 to the center 12b of the lateral pipe opening.

In the above described embodiment, the amplitude of the voltage across both the terminals of the transmitting coil 40 is measured to detect the electromagnetic coupling of the transmitting coil 40 and the receiving coil 33, but for detection the phase thereof may be measured or the phase as well as the amplitude may be measured.

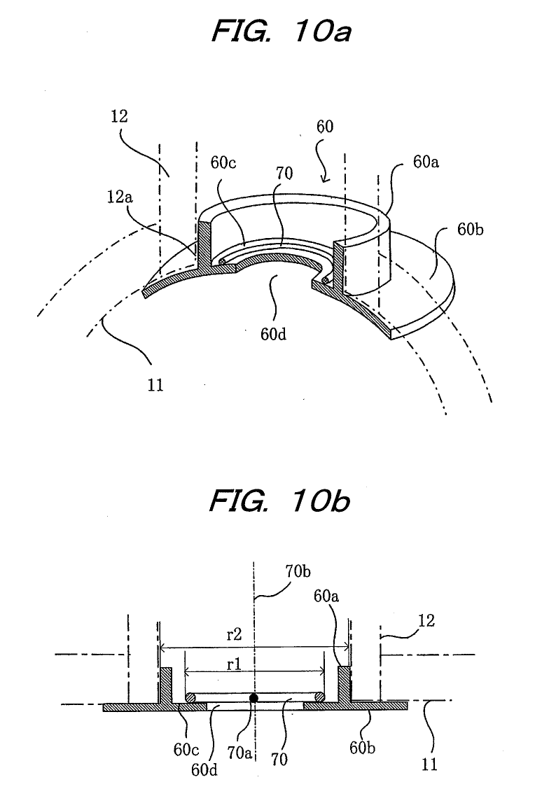

In the above described embodiment, the receiving coil 33 is mounted to the inner circumferential surface of the main pipe, so that the receiving coil 33 can be mounted with ease. However, the receiving coil 33 may be mounted to a position inside the lateral pipe opening 12a a predetermined distance away from the center of the lateral pipe opening. In such a case, a cap fitted into the lateral pipe opening as shown in FIG. 10 is prepared in order to mount the receiving coil on the cap.

### Embodiment 2

In Embodiment 1, the receiving coil is mounted to the inner circumferential surface of the main pipe, but it may be mounted to the lateral pipe opening. FIGS. 10a, 10b through FIGS. 16a, 16b show this embodiment.

A receiving coil 70 as shown in FIGS. 10a and 10b is similarly to the receiving coil 33 configured as a circular coil having an outer diameter r1 and made of a closed one-turn copper wire. The receiving coil 70 is a ring conductor through which an induced current flows when a fluctuating magnetic flux is generated in the coil loop thereof, and it may also be configured as a multi-turn coil. A cap 60 that is fitted into the lateral pipe opening is used in order to mount the receiving coil 70 to the lateral pipe opening 12a.

The cap 60 is a member made of, for example, elastic hard rubber, comprising a hollow cylindrical portion 60a having an outer diameter r2 substantially the same as the diameter of the lateral pipe opening 12a and fitted into the lateral pipe opening 12a, and a ring-shaped flange portion 60b that is formed below the cylindrical portion integrally therewith and is brought into contact with the inner circumferential surface of the main pipe. The cylindrical portion 60a may have its upper portion tapered in order to ensure that the cylindrical portion 60a is inserted into the lateral pipe opening.

To drain the sewage flowing into the lateral pipe 12, the cap 60 is provided at the bottom 60c of the hollow cylindrical portion 60a with a circular opening 60d that is coaxial with the hollow cylindrical portion 60a. The receiving coil 70 is mounted to the bottom 60c of the cap 60 using an adhesive or an adhesive tape such that a center axis 70b passing vertically through the center 70a thereof is coaxial with the center axis of the hollow cylindrical portion 60a. The cap 60 to which the receiving coil 70 is mounted can be manufactured in advance in the factory and transported to a site where the main pipe lining is performed.

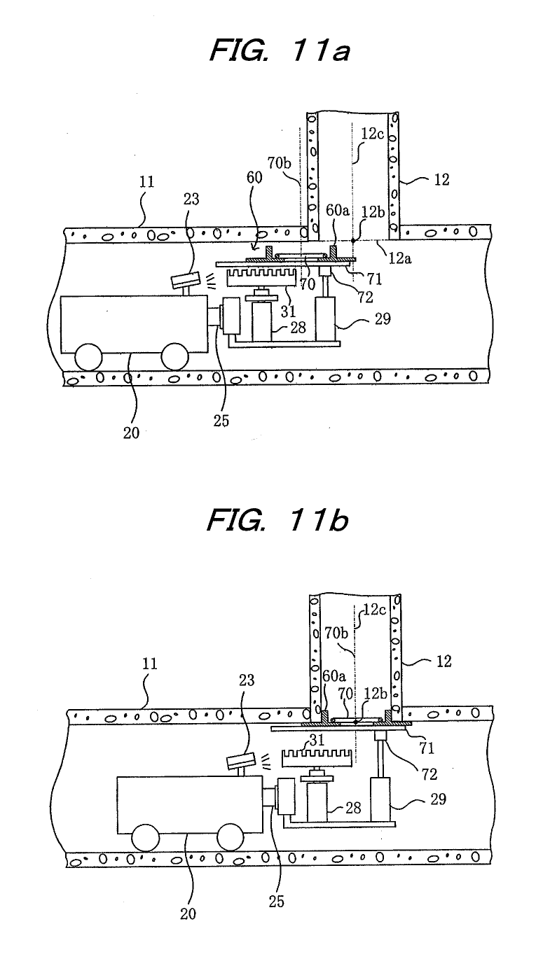

As shown in FIGS. 11a and 11b, a support plate 71 that can be rotated by a motor 72 is mounted on the cylinder 29 of the in-pipe robot 20. The support plate 71 is bent in accordance with the curvature of the inner surface of the main pipe, and the cap 60 to which the receiving coil 70 is mounted is disposed on the support plate 71.

The in-pipe robot 20 is moved from a position in FIG. 11a to a position in FIG. 11b where the center axis 70b of the receiving coil 70 becomes coaxial with the center axis 12c of the lateral pipe opening 12a. At this position, the support plate 71 is lifted to press the flange portion 60b of the cap 60 against the inner circumferential surface of the main pipe and fit the hollow cylindrical portion 60a into the lateral pipe opening 12a. The cap 60 is made of an elastic material. Therefore, once the hollow cylindrical portion 60a is fitted into the lateral pipe opening 12a, the cap 60 is brought into close contact with the lateral pipe due to its elasticity and fixed thereto. Similarly to Embodiment 1, the main pipe 11 is lined with the main pipe lining material 13 and the cap 60 is partially embedded in the main pipe lining material 13.

The cap 60 may be mounted to the lateral pipe opening using a dedicated robot instead of using the drilling in-pipe robot 20.

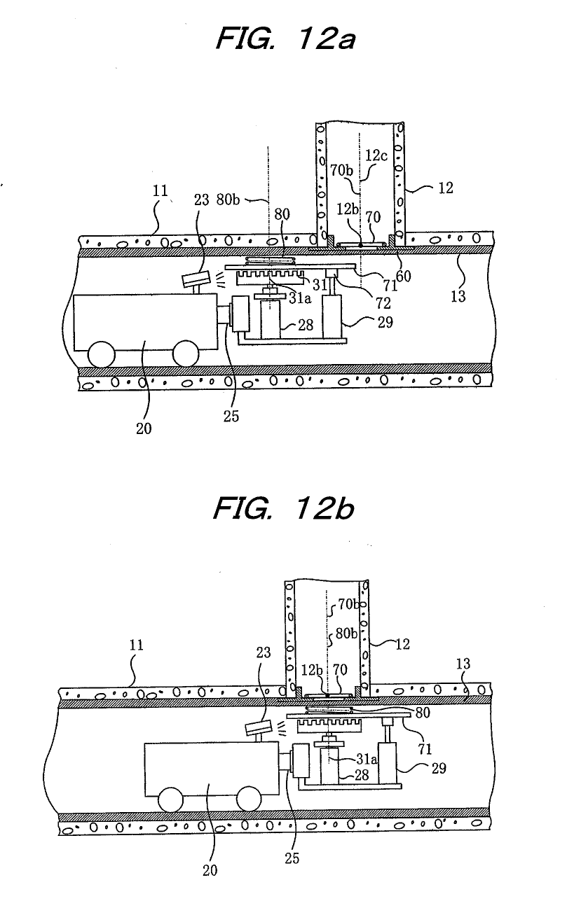

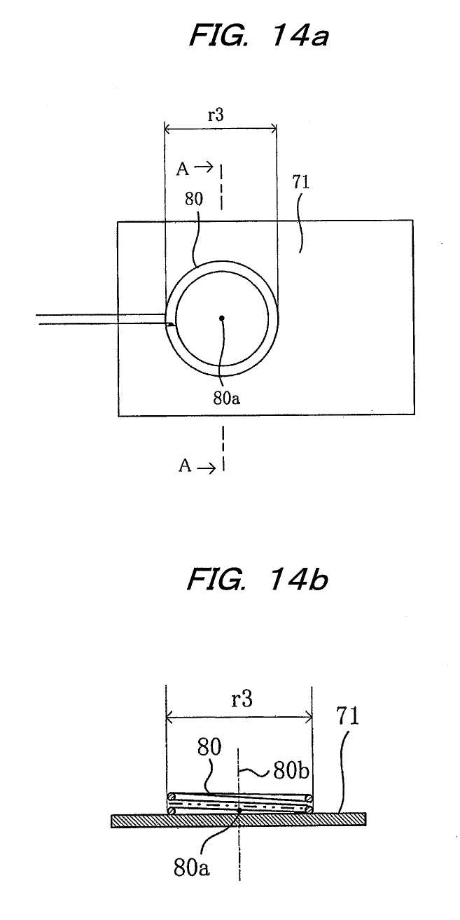

Next, as shown in FIGS. 12a and 12b, a transmitting coil 80 is mounted on the support plate 71 in such a manner that the coil center axis 80b thereof is coaxial with the rotation axis 31a of the drilling blade 31. The transmitting coil 80 has a coil diameter r3 substantially the same as the coil diameter r1 of the receiving coil 70 and it is configured as a circular multi-turn coil similarly to the transmitting coil 40. As shown in FIGS. 14a and 14b, the transmitting coil 80 is attached to the support plate 71 via an adhesive or an adhesive tape such that the coil center 80a is positioned at the center of the support plate 71.

The transmitting coil 80 has lead wires connected to both the terminals thereof and connected to the circuit shown in FIG. 8, as is similar to the transmitting coil 40 in Embodiment 1. A fluctuating magnetic flux in accordance with an alternating current supplied by the power supply 53 is generated in the coil loop of the transmitting coil 80.

The in-pipe robot 20 with the transmitting coil 80 mounted thereon is moved toward the lateral pipe opening from the position in FIG. 12a to the position where the electromagnetic coupling of the transmitting coil 80 and the receiving coil 70 becomes maximum, as shown in FIG. 12b. The control circuit 50 stops the in-pipe robot 20 at the position where the electromagnetic coupling becomes maximum.

The receiving coil 70 is disposed at the lateral pipe position at which the coil center axis 70b thereof coincides with the center 12b of the lateral pipe opening or the center axis 12c thereof, and the transmitting coil 80 is mounted at the position where the coil center axis 80b thereof is coaxial with the rotation axis 31a of the drilling blade 31. Accordingly, at the position where the electromagnetic coupling of the transmitting coil 80 and the receiving coil 70 becomes maximum and the center axes of both the coils are coaxial, the rotation axis 31a of the drilling blade 31 coincides with the center 12b of the lateral pipe opening or the center axis 12c thereof. Therefore, the in-pipe robot 20 stops.

The rotation axis 31a of the drilling blade 31 is likely to be inclined in the main pipe circumferential direction, so that, similarly to Embodiment 1, the motor 25 is driven at the stop position of the robot to swing the transmitting coil 80 and the drilling blade 31 in the main pipe circumferential direction for movement into a position in the circumferential direction where the electromagnetic coupling of the transmitting coil 80 and the receiving coil 70 becomes maximum.

In this way, the transmitting coil 80 and the drilling blade 31 is moved in the main pipe longitudinal direction as well as in the main pipe circumferential direction to the position where the electromagnetic coupling of the transmitting coil 80 and the receiving coil 70 becomes maximum and the center axes of both the coils coincide. Therefore, the rotation axis 31a of the drilling blade 31 can be positioned to the center 12b of the lateral pipe opening or the center axis 12c thereof, allowing a hole to be drilled precisely in the main pipe lining material.

At the position where the electromagnetic coupling of the transmitting coil 80 and the receiving coil 70 becomes maximum and the center axes of both the coils coincide, the drilling blade 31 is, as shown in FIG. 13a, lifted and rotated to drill a hole in the main pipe lining material 13 around the lateral pipe opening and cut the main pipe lining material 13 on the lateral pipe opening, the cap 60 as well as the receiving coil 70. This allows the lateral pipe opening to be made open to the main pipe 11, as shown in FIG. 13b.

The transmitting coil 80 is mounted coaxially with the rotation axis 31a of the drilling blade 31, so that the transmitting coil 80 would be damaged when a hole is drilled in the main pipe lining material 13. Therefore, a motor 72 is driven to rotate the support plate 71 for movement into a position where the transmitting coil 80 is kept out of contact with the drilling blade 31, as shown in FIG. 13a.

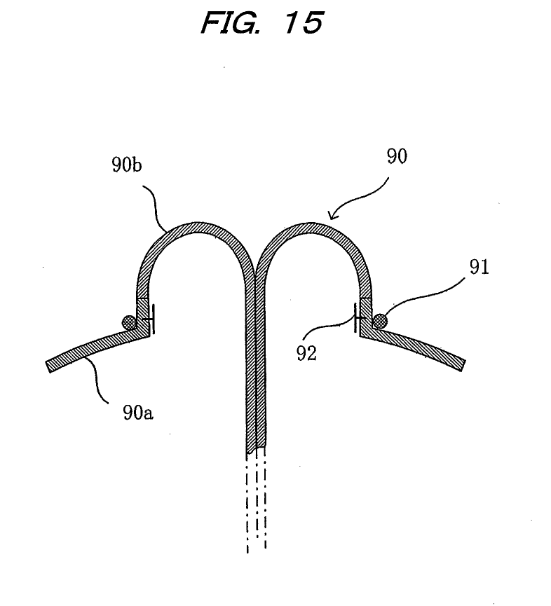

The receiving coil may be mounted to a lateral pipe lining material 90 shown in FIG. 15. The lateral pipe lining material 90 includes a resin-absorbent material 90b made of tubular flexible non-woven fabric impregnated with an uncured liquid setting resin and has one end folded out and cured to provide a ring-shaped flange portion 90a. A receiving coil 91 similar to the receiving coils 33, 70 is mounted on the flange portion 90a via an adhesive or an adhesive tape.

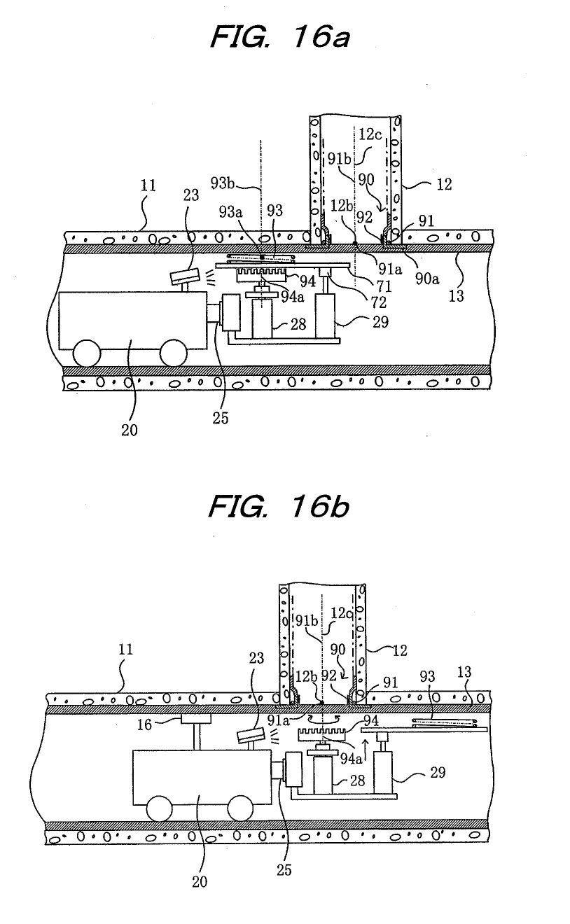

The lateral pipe lining material 90 is everted and inserted from the main pipe through the lateral pipe opening into the lateral pipe 12 and pressed against the inner circumferential surface of the lateral pipe. The liquid setting resin impregnated in the resin-absorbent material 90b is then heated and cured. In this state, the center axis 91b of the receiving coil 91 substantially coincides with the center axis of the flange portion 90a and the center axis 12c of the lateral pipe opening, as shown in FIG. 16a.

A transmitting coil 93 configured similarly to the receiving coils 40, 80 as a circular multi-turn coil having substantially the same diameter as that of the receiving coil 91 is mounted on the support plate 71 of the in-pipe robot 20 such that the center axis 93b extending vertically from the center 93a thereof is coaxial with the rotation axis 94a of a drilling blade 94.

When the in-pipe robot 20 moves and the electromagnetic coupling of the transmitting coil 93 and the receiving coil 91 becomes maximum, the in-pipe robot 20 stops. At this stop position, the motor 25 is driven to swing the transmitting coil 93 and the drilling blade 94 in the main pipe circumferential direction for movement into a position in the circumferential direction where the electromagnetic coupling of the transmitting coil 93 and the receiving coil 91 becomes maximum.

Thus, the transmitting coil 93 and the drilling blade 94 is moved in the main pipe longitudinal direction as well as in the main pipe circumferential direction to a position where the electromagnetic coupling of the transmitting coil 93 and the receiving coil 91 becomes maximum and the center axes of both the coils coincide. This allows the rotation axis 94a of the drilling blade 94 to be positioned to the center 12b of the lateral pipe opening or the center axis 12c thereof. The diameter of the drilling blade 94 is smaller than the inner ring diameter of the flange portion 90a. As shown in FIG. 16b, the drilling blade 94 is then lifted and rotated to drill a hole in the main pipe lining material 13 that blocks the lateral pipe opening without damaging the lateral pipe lining material 90.

To prevent the drilling blade from hitting the lateral pipe lining material and damaging it, a cylindrical member 92 (also called S-collar) made of a hollow steel material is mounted to the lateral pipe lining material 90 coaxially with the flange portion 90a thereof. When a fluctuating magnetic flux is generated in the hollow cylindrical member 92, an induced current flows therein, so that the hollow cylindrical member 92 can function similarly to the receiving coil 91.

In Embodiments 1 and 2, the transmitting coil is moved in the main pipe longitudinal direction to determine a position (x1 in FIG. 9a) where the electromagnetic coupling of the transmitting coil and the receiving coil becomes maximum, and, at this position, swung in the main pipe circumferential direction to further determine a position (θ1 in FIG. 9b) where the electromagnetic coupling becomes maximum. This corresponds to such an operation that, in a cylindrical coordinate in which the X axis is the generatrix of the main pipe passing through the coil center (x1, 0) of the receiving coil and the θ axis is the main pipe circumferential direction orthogonal to the X axis, the coil center of the transmitting coil is moved to the position (x1, 0) by varying ±θ in the θ direction at the x direction position x1. Thus, the centers of both the coils and the center axes thereof coincide.

The transmitting coil is not only moved in the X direction to determine the position where the electromagnetic coupling of both coils becomes maximum and then moved in the θ direction, but also, for example, moved forward in the X direction while swinging right and left in the θ direction by a predetermined angle. In a case where a change appears in the electromagnetic coupling of the transmitting coil and the receiving coil, i.e., in a case where overlapping occurs in both the coils, the transmitting coil is first moved in the X direction to determine the position where the electromagnetic coupling becomes maximum and then moved in the θ direction to determine the position where the electromagnetic coupling becomes maximum. Or conversely, the transmitting coil may be moved first in the θ direction to determine the position where the electromagnetic coupling becomes maximum and then moved in the x direction to determine the position where the electromagnetic coupling becomes maximum.

In this way, the transmitting coil is moved together with the drilling blade in the main pipe longitudinal direction and in the main pipe circumferential direction until the coil center axis thereof coincides with the center axis of the receiving coil, and a hole is drilled in the main pipe lining material at the position where the center axes of both the coils coincide. At the position where the center axes of both the coils coincide, the rotation axis of the drilling blade coincides with the center or the center axis of the lateral pipe opening. Therefore, a hole is drilled precisely in alignment with the lateral pipe opening in the main pipe lining material that blocks the lateral pipe opening.

The drilling blades 31, 94 are configured as a cylindrical hole saw without any rod-shaped drill at the center thereof, but may be equipped with a drill at the center, or may be configured as an umbrella-shaped cutter whose diameter decreases toward the tip.

The diameter of the drilling blades 31, 94 may be made smaller with a margin than the inside diameter of the lateral pipe or the inside diameter of the lateral pipe lining material, for example, so small as about half the inside diameter thereof or less to just drill a temporary hole. After drilling the temporary hole, a step may be provided in which the remaining part of the main pipe lining material that still blocks the lateral pipe opening is removed precisely.

In Embodiments 1, 2, the position where the electromagnetic coupling of the transmitting coil and the receiving coil becomes maximum is detected, and the motors 21, 25 are automatically controlled to this position to perform the drilling. Instead of such an automatic control, the output values of the amplitude/phase detection circuit 25 that vary in accordance with movement of the transmitting coil, for example, the amplitude values of the voltages as shown in FIGS. 9a and 9b may be monitored by a monitor installed inside the work truck, and, when its values are at the minimum values A1, B1, respectively, i.e., when the electromagnetic coupling becomes maximum, the motors 21, 25 may be manually powered down to position the rotation axis of the drilling blade to the center or center axis of the lateral pipe opening and perform the drilling. In such a case, the motors are controlled manually, but the amplitude value of the voltage can be monitored by a monitor, thereby allowing the drilling blade to be positioned with ease and precisely.

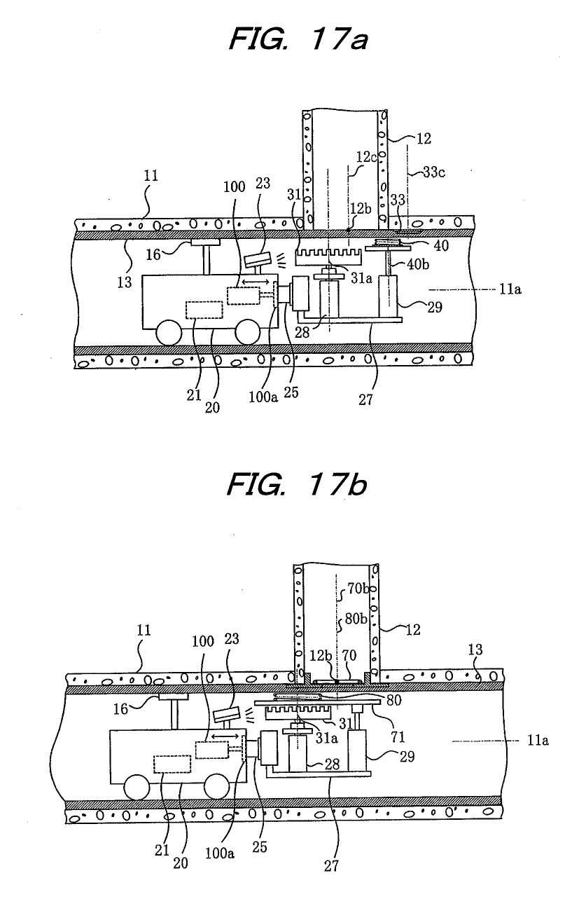

In Embodiments 1 and 2, the movement of the in-pipe robot 20 may be locked when the in-pipe robot 20 approaches near the drilling position, and a separate drive system may be used to move the drilling blade and the transmitting coil. FIGS. 17a and 17b show these embodiments.

FIG. 17a is a view showing a modification of Embodiment 1. The in-pipe robot 20 is loaded with a cylinder 100 with a cylinder head 100a, to which the motor 25 is fixed. The cylinder 100 is mounted to the in-pipe robot 20 such that the support plate 27 that supports the motor 25 and the cylinders 28, 29 can be moved in conjunction in the main pipe longitudinal direction. The in-pipe robot 20 stops in movement when the transmitting coil 40 moves near the receiving coil 33 and the electromagnetic coupling is generated in both the coils with the amplitude value shown in FIG. 9a reduced a predetermined value. In this state, the bracing member 16 is lifted to fix the in-pipe robot 20 inside main pipe. The subsequent longitudinal movement of the drilling blade 31 and the transmitting coil 40 is not done by moving the in-pipe robot 20 by the motor 21, but by driving the cylinder 100.

Such an arrangement provides an advantage that the in-pipe robot 20 can be moved at high speed until the electromagnetic coupling starts to occur in both the coils, and, once the electromagnetic coupling starts to occur, the drilling blade 31 and the transmitting coil 40 can be moved at low speed in the main pipe longitudinal direction by the cylinder 100 and in the main pipe circumferential direction by the motor 25. This allows a drilling target position to be finely detected.

FIG. 17b is a view showing a modification of Embodiment 2. Similarly as shown in FIG. 17a, the support plate 27 that supports the motor 25 and the cylinders 28, 29 is moved in conjunction in the main pipe longitudinal direction by the cylinder 100. Once the electromagnetic coupling starts to occur between the transmitting coil 80 and the receiving coil 70, the drilling blade 31 and the transmitting coil 80 is moved in the main pipe longitudinal direction by the cylinder 100 and in the main pipe circumferential direction by the motor 25 in order to center the drilling blade.

### Embodiment 3

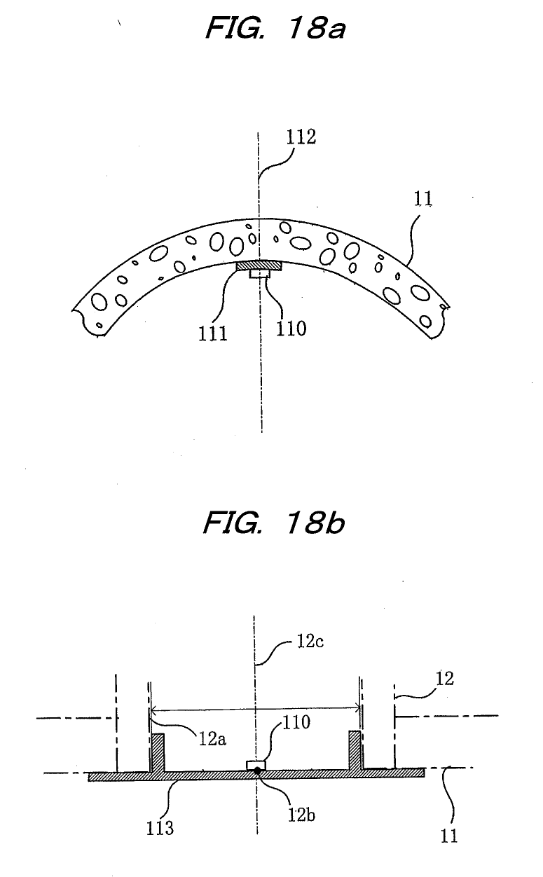

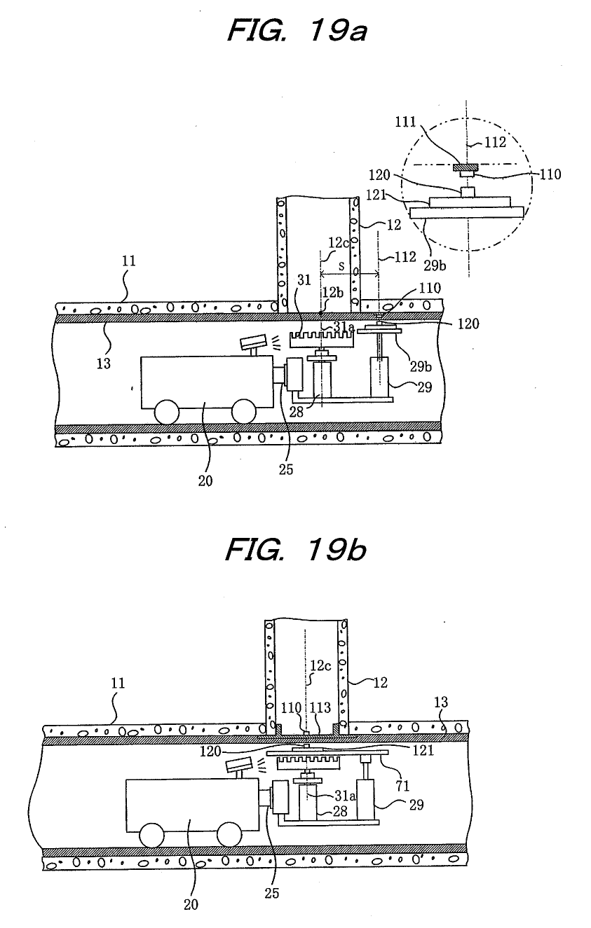

In Embodiments 1 and 2, the receiving coils 33, 70, 91 are used as a marker that indicates the drilling center. However, a small-sized magnet may be used as a marker. FIGS. 18a, 18b, 19a and 19b show Embodiment 3.

A magnet 110 used in Embodiment 3 is made of, for example, samarium cobalt or neodymium, having a diameter of 10 ϕ-20 ϕ and a thickness of about 1 mm-5 mm. As shown in FIG. 18a and FIG. 19a, the magnet 100 is fixed to a board 111 by an adhesive. The board 111 is mounted to the inner circumferential surface of the main pipe 11 via an adhesive or an adhesive tape at a position separated a predetermined distance S from the center 12b of the lateral pipe opening 12a in such a manner that the magnet 110 is positioned on the vertical line 112. The mounting is performed in the same way as the receiving coil 33 shown in FIGS. 3a and 3b is mounted. The magnet 110 may be mounted directly to the inner circumferential surface of the main pipe 11 without using the board 111.

The magnet 110 may not be mounted to the inner circumferential surface of the main pipe, but may be mounted using an adhesive or an adhesive tape to the center of a cap 113 that is fitted into the lateral pipe opening 12a, as shown in FIG. 18b. The cap 113 has the same shape as the cap 60 shown in FIGS. 10a and 10b without the opening 60d, and the magnet 110 is positioned on the center axis 12c passing through the center 12b of the lateral pipe opening 12a when the cap 113 is fitted into the lateral pipe opening 12a. The cap 113 is mounted to the lateral pipe opening in the same way as the receiving coil 70 shown in FIGS. 11a and 11b is mounted.

A magnetic sensor 120 consisting of a Hall element is used as a sensor that detects the position of the magnet 110 thus mounted. In a case where the magnet 110 is, as shown in FIG. 18a, mounted to the inner circumferential surface of the main pipe 11, a circuit board 121 for the magnetic sensor 120 is mounted on the head 29b of the cylinder 29 such that the magnetic sensor 120 is positioned on the center axis of the cylinder 29, as shown in FIG. 19a.

Once the main pipe 11 has been lined, the magnet 110 is embedded in the main pipe lining material 13. When the in-pipe robot 20 moves in the longitudinal direction in the lined main pipe and the magnetic sensor 120 comes up to a position on the vertical line 112 at which the magnet 110 is mounted, the magnetic sensor 120 detects the maximum density of magnetic flus. The in-pipe robot 20 is then stopped at this position. FIG. 19a shows the state in which the in-pipe robot 20 has stopped. In this state, the rotation axis 31a of the drilling blade 31 becomes coaxial with the center 12b of the lateral pipe opening and the center 12c thereof passing through the center 12b. The cylinder 28 is then lifted and the motor 30 is driven to rotate the drilling blade 31 and drill a hole in the main pipe lining material 13. A circular hole corresponding to the circle having the inside diameter of the lateral pipe is drilled in the main pipe lining material 13, causing the lateral pipe 12 to communicate with the main pipe 11.

In a case where the magnet 110 is, as shown in FIG. 18b, is mounted to the center of the cap 113, the magnetic sensor 120 and the circuit board 121 are, as shown in FIG. 19b, mounted on the support plate 71 rotatablely mounted to the cylinder 29 such that the magnetic sensor 120 coincides with the rotation axis 31a of the drilling blade 31.

When the in-pipe robot 20 moves in the longitudinal direction in the lined main pipe and the magnetic sensor 120 comes up to the position of the center axis 12c of the lateral pipe opening 12a, the magnetic sensor 120 detects the maximum density of magnetic flus. The in-pipe robot 20 is then stopped at this position. FIG. 19b shows the state in which the in-pipe robot 20 has stopped. In this state, the rotation axis 31a of the drilling blade 31 becomes coaxial with the center 12b of the lateral pipe opening and the center 12c thereof passing through the center 12b. The support plate 71 is then rotated, the cylinder 28 is lifted and the motor 30 is driven. This causes the drilling blade 31 to rotate, and a circular hole corresponding to the circle having the inside diameter of the lateral pipe is drilled in the main pipe lining material 13, causing the lateral pipe 12 to communicate with the main pipe 11.

For the magnet as a marker, as is the same as for the receiving coil as a marker, the rotation axis 31a of the drilling blade 31 and the magnetic sensor 120 is likely to deviate from the vertical in the main pipe circumferential direction. Therefore, it is necessary to move the drilling blade 31 and the magnetic sensor 120 in conjunction in the main pipe circumferential direction for positioning depending upon the deviation.

The steps and sequences of moving the drilling blade 31 and the magnetic sensor 120 in the main pipe longitudinal direction and in the main pipe circumferential direction is the same as those of moving the drilling blade and the transmitting coil as described in Embodiments 1 and 2. Also for the magnet as a marker, the magnetic sensor 120 is moved in the main pipe longitudinal direction as well as in the main pipe circumferential direction to the position where the maximum density of magnetic flux is detected. Therefore, the rotation axis 31a of the drilling blade 31 is positioned to the center 12b of the lateral pipe opening and the center axis 12c thereof, allowing the main pipe lining material to be cut precisely in alignment with the lateral pipe opening.

### KEY TO THE SYMBOLS

10 manhole
11 main pipe
12 lateral pipe
13 main pipe lining material
14 work truck
16 bracing member
20 in-pipe robot
21 motor
23 television camera
24 lighting device
25 motor
26 mount
27 support plate
28, 29 cylinder
28a, 29a head
30 motor
31 drilling blade
32 board
33 receiving coil (second coil)
40 transmitting coil (first coil)
41 board
50 control circuit
52 amplitude/phase detection circuit
53 AC power supply
60 cap
70 receiving coil
71 support plate
72 motor
80 transmitting coil
90 lateral pipe lining material
91 receiving coil
92 hollow cylindrical member
93 transmitting coil
94 drilling blade
100 cylinder
110 magnet
120 magnetic sensor

1. A drilling apparatus for drilling a hole from a main pipe side in a main pipe lining material that blocks a lateral pipe opening, comprising:
an in-pipe robot that moves inside the main pipe;
a rotatable drilling blade mounted on the in-pipe robot to drill a hole in the main pipe lining materials;
a sensor mounted on the in-pipe robot to detect the position of a marker that is disposed at the center of the lateral pipe opening or at a position separated a predetermined distance from the center thereof; and
moving means for moving the drilling blade and the sensor in conjunction in the main pipe longitudinal direction and in the main pipe circumferential direction,
wherein the sensor is mounted at the center of rotation of the drilling blade or at a position separated the predetermined distance from the center of rotation thereof, and the drilling blade and the sensor are moved in conjunction in the main pipe longitudinal direction and in the main pipe circumferential direction until the marker is detected, a hole being drilled in the main pipe lining material at the position at which the marker is detected.

2. A drilling apparatus according to claim 1, wherein the marker is a coil, and the sensor is a coil that generates a fluctuating magnetic flux, the center of the sensor coil at which the electromagnetic coupling of the marker coil and the sensor coil becomes maximum being detected as a marker position.

3. A drilling apparatus according to claim 1, wherein the marker is a magnet, and the sensor is a magnetic sensor, a position where a magnetic sensor signal becomes maximum being detected as a marker position.

4. A drilling apparatus according to claim 1, wherein the movement in the main pipe circumferential direction is a swing about the main pipe axis.

5. A drilling apparatus according to claim 1, wherein the position separated the predetermined distance from the center of the lateral pipe opening lies on the inner circumferential surface of the main pipe.

6. A drilling method for drilling a hole from a main pipe side in a main pipe lining material that blocks a lateral pipe opening, comprising;
disposing, prior to lining a main pipe, a marker at the center of the lateral pipe opening or at a position separated a predetermined distance from the center thereof; and,
moving, after lining the main pipe, in conjunction inside the main pipe a sensor that detects a marker position and a rotatable drilling blade that drills a hole in the main pipe lining material,
wherein the sensor is mounted at the center of rotation of the drilling blade or at a position separated the predetermined distance from the center of rotation thereof, and the sensor and the drilling blade are moved in the main pipe longitudinal direction and in the main pipe circumferential direction until the sensor detects the marker position, a hole being drilled in the main pipe lining material at the position at which the marker is detected.

7. A drilling method according to claim 6, wherein the movement in the main pipe circumferential direction is a swing about the main pipe axis.

8. A drilling method according to claim 7, wherein, in a case where the sensor is swung and the marker position is not detected, the sensor is moved forward a predetermined amount in the main pipe longitudinal direction and swung until the marker position is detected.
